(19) United States
(12) Patent Application Publication
(10) Pub. No.: US 2010/0005966 A1
(43) Pub. Date: Jan. 14, 2010

(54) CO2 CAPTURE USING SOLAR THERMAL ENERGY

(75) Inventor: Louis Wibberley, Garden Suburb (AU)

Correspondence Address: SUGHRUE MION, PLLC, 2100 PENNSYLVANIA AVENUE, N.W., SUITE 800, WASHINGTON, DC, 20037, US

(73) Assignee: COMMONWEALTH SCIENTIFIC AND INDUSTRIAL RESEARCH ORGANSATION, Campbell, AU Capitol Territory (AU)

(21) Appl. No.: 12/374,017

(22) PCT Filed: Jul. 17, 2007
(86) PCT No.: PCT/AU07/00994

§ 371 Date: Apr. 8, 2009

(30) Foreign Application Priority Data
Jul. 17, 2006 (AU) 2006903840

(51) Int. Cl. B01D 53/14; B01D 53/18; F24J 2/34

(52) U.S. Cl. 95/179; 96/181

(57) ABSTRACT

At an absorber station, CO₂ is absorbed from a gas stream into a suitable solvent whereby to convert the solvent into a CO₂-enriched medium, which is conveyed to a desorber station, typically nearer to a solar energy field than to the absorber station. Working fluid, heated in the solar energy field by insolation, is employed to effect desorption of CO₂ from the CO₂-enriched medium, whereby to produce separate CO₂ and regenerated solvent streams. The regenerated solvent stream is recycled to the absorber station. The CO₂-enriched medium and/or the regenerated solvent stream may be selectively accumulated so as to respectively optimise the timing and rate of absorption and desorption of CO₂ and/or to provide a storage of solar energy.

### FIELD OF THE INVENTION

This invention relates generally to the use of solar energy for the recovery of carbon dioxide from gas streams. The invention has particular application to CO₂ recovery from flue gases generated by coal- and gas-fired power plants or from process gases in a wide variety of industrial processes including steel plants, smelters, cement kilns and calciners. The term “process gases” refer to gas streams fed to or from a process, and embraces, e.g. syngas feed to an industrial furnace, and blast furnace gas in a steel plant.

### BACKGROUND OF THE INVENTION

There is rapidly growing pressure for stationary sources of CO₂ emissions such as power stations, to make step reductions in greenhouse gas (GHG) emissions through 1) capturing the CO₂ formed from the process, and 2) storing the CO₂ by various geological means. Most involve injecting CO₂ in a supercritical or “liquefied” state into deep aquifers, coal seams and adjacent strata, or at depth in the ocean, or converting the CO₂ into a solid mineral form.

In the case of power stations, as an example, there are at present three main approaches to CO₂ separation from new or existing power plants: 1) post combustion capture, 2) precombustion capture, and, 3) oxygen combustion with flue gas liquefaction. In this context, the present invention is primarily applicable to post combustion capture, though the invention could also be used for precombustion capture where heat is required for solvent regeneration.

In post combustion capture, the CO₂ in flue gases is preferentially separated from nitrogen and residual oxygen using a liquid solvent in an absorber. The CO₂ is then removed from the solvent in a process called desorption (or regeneration, and sometimes termed “stripping”), thus allowing the solvent to be reused. The desorbed CO₂ is then liquefied by compression and cooling, with appropriate drying steps to prevent hydrate formation. The main disadvantage of this process is that the CO₂ partial pressure is relatively low (compared to the two alternative approaches mentioned above), which necessitates the use of CO₂ selective solvents. The regeneration of these solvents releases an essentially pure CO₂ stream, but this step is relatively energy intensive. Overall, this reduces the electrical power output by around 20%, due to the need to provide low temperature heat (approximately 65% of the total energy required) and work to drive the CO₂ liquefaction plant and other auxiliary equipment. Both heat and work are also required for dehydration of the liquefied product CO₂. The net effect is to reduce the thermal efficiency of the plant by around 9 percentage points.

Post combustion capture in this form is applicable to other stationary CO₂ sources, such as steel plants, cement kilns, calciners and smelters.

It has been previously noted by the present inventor that renewable energy sources can be used to provide input to the electricity grid by either direct or indirect integration, and that this synergy can reduce the emissions intensity of fossil fuels and support the uptake of renewables. An example of direct integration is the use of solar thermal energy to provide steam or hot fluids to a host power plant for the purpose of heating the working fluid (usually water), for raising steam, or for superheating steam. An Australian example is the Solar Heat and Power plant located at Liddell, NSW. This arrangement provides hot water to the power plant for feed water heating to displace extraction steam from the low pressure turbine stages.

The basis for indirect integration is that solar thermal energy can be applied anywhere to the power grid, thereby displacing the power required from fossil fuelled power stations. The avoided CO₂ emissions may be allocated to a range of emitters, including non-grid sources. The grid thereby facilitates the use of solar thermal energy by providing backup and reserve power.

The use of solar thermal energy for post combustion capture has been considered in a number of studies by the present inventor and co-workers at CSIRO, with the solar heat being used for directly providing heat for the desorber of the capture plant. This direct integration is similar to that used for augmenting power station output by providing feed water heating, and involves transferring the solar energy as a hot working fluid (mostly hot water under pressure, though low pressure steam has also been considered) to the desorber of the post combustion capture process, at temperatures of up to 150° C., via thermally insulated pipes.

An object of the invention, at least in one or more aspects, is to more effectively employ solar energy to address the aforedescribed problem of the reduction of thermal efficiency incurred by post combustion capture of CO₂.

It is a further object of the invention, at least in one or more aspects, to effectively employ solar energy as a source of additional energy in a power generation system or industrial process.

### SUMMARY OF THE INVENTION

In the first aspect, the invention provides a method of recovering CO₂ from a gas stream, including:
at an absorber station, absorbing CO₂ from a gas stream into a suitable solvent whereby to convert said solvent into a CO₂-enriched medium;
conveying the CO₂-enriched medium to a desorber station nearer to a solar energy field than to said absorber station;
employing working fluid, heated in said solar energy field by insolation, to effect desorption of CO₂ from said CO₂-enriched medium at said desorber station, whereby to produce separate CO₂ and regenerated solvent streams; and
recycling the regenerated solvent stream to said absorber station.

In the first aspect of the invention, there is further provided apparatus for recovering CO₂ from a gas stream, including:
an absorber station arranged to receive the gas stream and to absorb CO₂ from the gas stream into a suitable solvent whereby to convert said solvent into a CO₂-enriched medium;
a solar energy field;
a desorber station disposed nearer to the solar energy field than to the absorber station; and
means to convey the CO₂-enriched medium from the absorber station to the desorber station;
wherein said desorber station is configured to employ working fluid, heated in said solar energy field by insolation, to effect desorption of CO₂ from said CO₂-enriched medium at said desorber station, whereby to produce separate CO₂ and regenerated solvent streams;
and wherein means is provided to recycle the regenerated solvent stream to said absorber station.

In a second aspect, the invention provides a method of injecting solar energy into a power generation or other industrial system, including:
directing a process gas stream for or from the power generation or other industrial system to an absorber station, and therein absorbing CO₂ from the gas stream into a suitable solvent whereby to convert said solvent into a CO₂-enriched medium;
conveying the CO₂-enriched medium to a desorber station nearer to a solar energy field than to said absorber station;
employing working fluid, heated in said solar energy field by insolation, to effect desorption of CO₂ from said CO₂-enriched medium at said desorber station, whereby to produce separate CO₂ and regenerated solvent streams; and
recycling the regenerated solvent stream to said absorber station.

The invention still further provides, in its second aspect, apparatus for injecting solar energy into a power generation or other industrial system, including:
an absorber station arranged to receive a process gas stream for or from the power generation or other industrial system and therein to absorb CO₂ from the gas stream into a suitable solvent whereby to convert said solvent into a CO₂-enriched medium;
a solar energy field;
a desorber station disposed nearer to the solar energy field than to said absorber station; and
means to convey the CO₂-enriched medium from the absorber station to the desorber station;
wherein said desorber station is configured to employ working fluid, heated in said solar energy field by insolation, to effect desorption of CO₂ from said CO₂-enriched medium at said desorber station, whereby to produce separate CO₂ and regenerated solvent streams; and
wherein means is provided to recycle the regenerated solvent stream to said absorber station.

Advantageously, in the methods of the first and second aspects of the invention the CO₂-enriched medium and/or the regenerated solvent stream are selectively accumulated so as to respectively optimise the timing and rate of said absorption and desorption of CO₂, and/or to provide a storage of solar energy.

Advantageously, the apparatus of the first or second aspect of the invention further includes a plurality of storage vessels whereby the CO₂-enriched medium and/or the regenerated solvent stream are selectively accumulated in the vessels so as to respectively optimise the timing and rate of said absorption and desorption of CO₂, and/or to provide a storage of solar energy.

In a third aspect, the invention provides a method of recovering CO₂ from a gas stream including:
at an absorber station absorbing CO₂ from the gas stream into a suitable solvent whereby to convert said solvent into a CO₂-enriched medium;
conveying the CO₂-enriched medium to a desorber station; and
employing working fluid, heated in said solar energy field by insolation, to effect desorption of CO₂ from said CO₂-enriched medium at said desorber station, whereby to produce separate CO₂ and regenerated solvent streams; and
recycling the regenerated solvent stream to said absorber station;
wherein the CO₂-enriched medium and/or the regenerated solvent stream are selectively accumulated so as to respectively optimise the timing and rate of said absorption and desorption of CO₂, and/or to provide a storage of solar energy.

The invention still further provides, in its third aspect, apparatus for recovering CO₂ from a gas stream, including:
an absorber station arranged to receive the gas stream and to absorb CO₂ from the gas stream into a suitable solvent whereby to convert said solvent into a CO₂-enriched medium;
a solar energy field;
a desorber station; and
means to convey the CO₂-enriched medium from the absorber station to the desorber station;
wherein said desorber station is configured to employ working fluid, heated in said solar energy field by insolation, to effect desorption of CO₂ from said CO₂-enriched medium at said desorber station, whereby to produce separate CO₂ and regenerated solvent streams;
and wherein the apparatus further includes means to recycle the regenerated solvent stream to said absorber station, and a plurality of storage vessels whereby the CO₂-enriched medium and/or the regenerated solvent stream are selectively accumulated in the vessels so as to respectively optimise the timing and rate of said absorption and desorption of CO₂, and/or to provide a storage of solar energy.

Most conveniently, the absorber station is located adjacent a source of the gas stream, e.g. a boiler or furnace to which said gas stream is being fed or from which said gas stream is emitted as a flue gas stream. The boiler or furnace may be part of an electrical power generation plant, e.g. a coal-fired electrical power station.

Preferably, said working fluid, heated in said solar field by insolation, is also employed as an energy source in compression and liquefaction of the CO₂ in said separate CO₂ stream.

The arrangement of the first and second aspects of the invention allows the production of lower temperature heat from the solar energy field, thereby increasing sun-to-heat efficiency, and also substantially reduces energy losses otherwise incurred from transferring hot working fluids over long distances between the solar energy field and the desorber station, which is conventionally located adjacent to the absorber station. The separation of the desorber station from the absorber station means that the relatively cooler solvent solutions are transferred over the greater distances.

In the third aspect of the invention, storage of solvent in one or more vessels permits provision of CO₂-lean solvent to the absorber during periods of low insolation, and additional flow of CO₂-rich solvent to the desorber station to utilize peaks in solar energy production. This storage in effect disconnects the absorber and thereby enables solar energy to be used to capture a larger proportion of the total CO₂. It also allows process optimization by varying desorption conditions to match variations in insolation, thereby improving the efficiency of solar energy production and overall solar-to-CO₂ capture efficiency.

More generally, storage of the CO₂-lean solvent can be a low cost manner of storing solar energy, e.g. for periods of low or no insolation.

### BRIEF DESCRIPTION OF THE DRAWINGS

The invention will now be further described, by way of example only, with reference to the accompanying drawings, in which:

FIG. 1 is a diagram of an electrical power generation plant fitted for CO₂ post combustion capture according to a first embodiment of the first and second aspects of the invention.

FIG. 2 depicts in more schematic form a modification of the configuration of FIG. 1 also incorporating an embodiment of the third aspect of the invention; and

FIGS. 3 and 4 are diagrams of further embodiments of the invention.

### DESCRIPTION OF EMBODIMENTS OF THE INVENTION

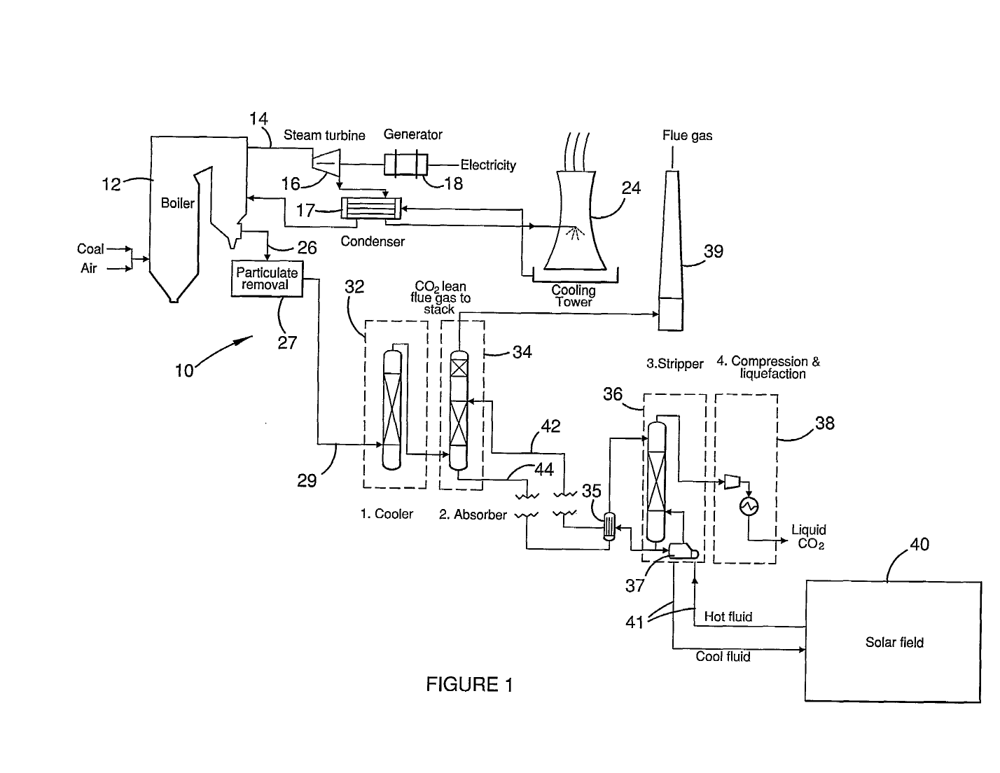

FIG. 1 depicts the essentials of a coal-fired power plant 10. Coal and air are delivered to a large scale boiler system 12 which heats large volumes of water to generate steam 14 for driving a steam turbine 16. Turbine 16 in turn powers a generator 18 that produces electricity as its output. The steam recovered from turbine 16 passes through a condenser 17 associated with a cooling tower 24, for recycling to the boiler. Flue gases 26 from boiler 12 are treated (at 27) to remove most particulates and other contaminants such as SO₂ and SO3, and then passed at 29 to a four-stage plant for post-combustion capture of carbon dioxide. At stage 1, indicated at 32, the cleaned flue gases are cooled to a temperature suitable for efficient absorption of CO₂ from the gases by a suitable solvent system. These solvents are also at times referred to as sorbents. At stage 2, comprising absorption station 34, the cleaned and cooled flue gases are scrubbed by contact with such a solvent system, e.g. a system containing monoethanolamine (MEA) or another amine or aqueous amonia. The solvent selectively absorbs CO₂ in a weakly bonded form. The CO₂-rich medium stream is then passed to the third stage, desorber or regeneration station 36, where the solvent is regenerated by heating it and contacting it with steam to desorb the CO₂, forming a CO₂-lean solvent.

The CO₂-lean flue gas from absorber station 34 is passed to a flue stack 39 for release into the atmosphere while the desorbed CO₂ from desorber/regeneration station 36 is compressed, cooled, dehumidified and liquefied, in station 38, for subsequent transport and storage. The CO₂-lean regenerated solvent is recycled to absorber station 34, exchanging its heat with the incoming CO₂-rich solvent at heat exchanger 35.

It will be appreciated that, in particular plants, there may be more than one CO₂-absorber at station 34 and/or more than one CO₂-desorber at station 36. Moreover, within an individual desorber, there may well be multiple stages within the column.

In conventional practice of post combustion capture of CO₂, the heat energy for regeneration/desorber station 36 is obtained from steam turbine 16, with the effects previously discussed. In accordance with a preferred practice of the first aspect of the invention, desorber station 36 and liquefaction stage 38 are sited remote from the power plant 10 and absorption station 34, and located immediately adjacent a solar energy field 40. Field 40 may typically be an open array of solar collectors mounted above ground and sufficiently spaced to allow use of the land below for other purposes, e.g. grazing of sheep or cattle. The array may, for example, be 2×2 km in extent. The solar collectors heat a working fluid, typically water, which is then employed to provide the required energy to heat the CO₂-rich solvent stream to effect desorption of the CO₂ and regeneration of the solvent. The working fluid circulates to heat exchange at 37 via pipe network 41. Respective pipes 42, 44 convey the CO₂-rich solvent from absorber station 34 to desorber station 36, and the CO₂-lean solvent in the reverse direction.

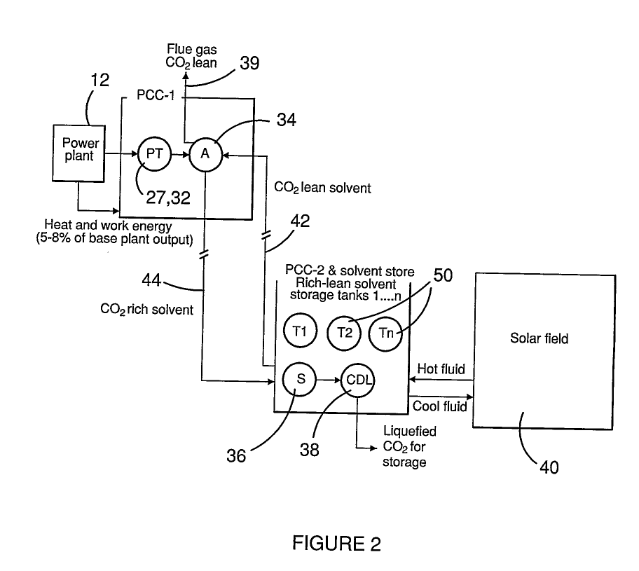

In a modified embodiment, depicted highly schematically in FIG. 2, that incorporates the third aspect of the invention, solvent storage vessels 50, designated T1 . . . Tn, are provided adjacent desorber station 36. Vessels 50 may typically be standard storage tanks of the kind employed in the petroleum industry.

Storage of solvent in vessels 50 allows provision of CO₂-lean solvent to the absorber during periods of low insolation, and additional flow of CO₂-rich solvent to the desorber to utilize peaks in solar energy production. This storage disconnects the absorber, thereby enabling solar energy to be used to capture a larger proportion of the total CO₂. It also allows process optimization by varying desorption conditions to match variations in insolation, thereby improving the efficiency of solar energy production and overall solar-to-CO₂ capture efficiency.

CO₂-lean solvent can be stored indefinitely, enabling the absorber to operate when solar energy is not available. It will be appreciated that storage of the CO₂-lean solvent is an especially effective means of low-cost storage of solar energy for periods of low or zero insolation. In solar shoulder periods, the thermal efficiency of the solar energy field will be higher if a lower temperature is provided to the working fluid. Under these conditions it may be advantageous to partially strip only the richest solvent.

While it is usually preferred that the storage vessels 50 be located adjacent the desorber station, it may be more convenient in particular cases to locate them adjacent the power plant.

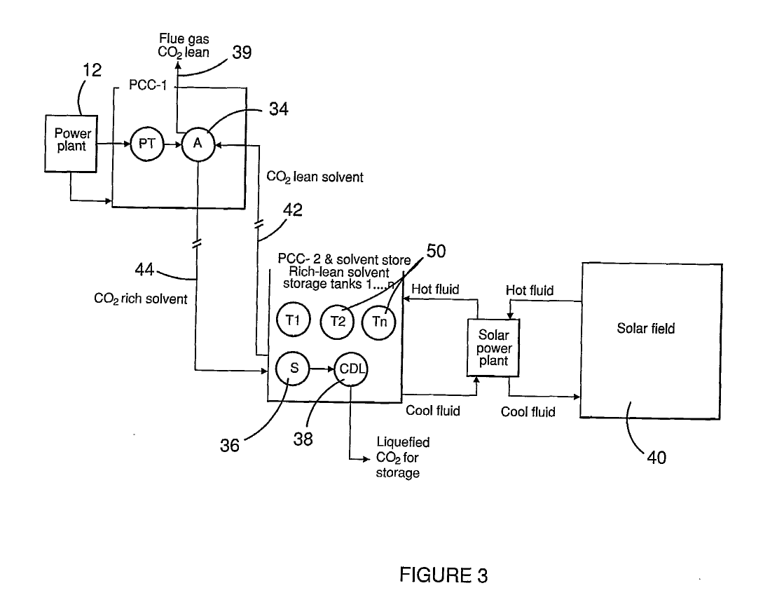

The solar energy field(s) 40 can be configured to provide energy for a number of other purposes which may integrate with the desorber and/or provide work or electrical energy. For example, steam or other vapours could be supplied from the solar field(s) to drive a turbine to generate electricity, and/or to provide CO₂ compression work at liquefaction stage 38. The exhaust from the turbine can then provide a proportion of the heat energy for the desorption and dehydration processes, and heat from CO₂ compression can be used to further augment solar heat sources. This combined heat and power option will have significantly higher efficiency than for power generation alone. This configuration is depicted schematically in FIG. 3.

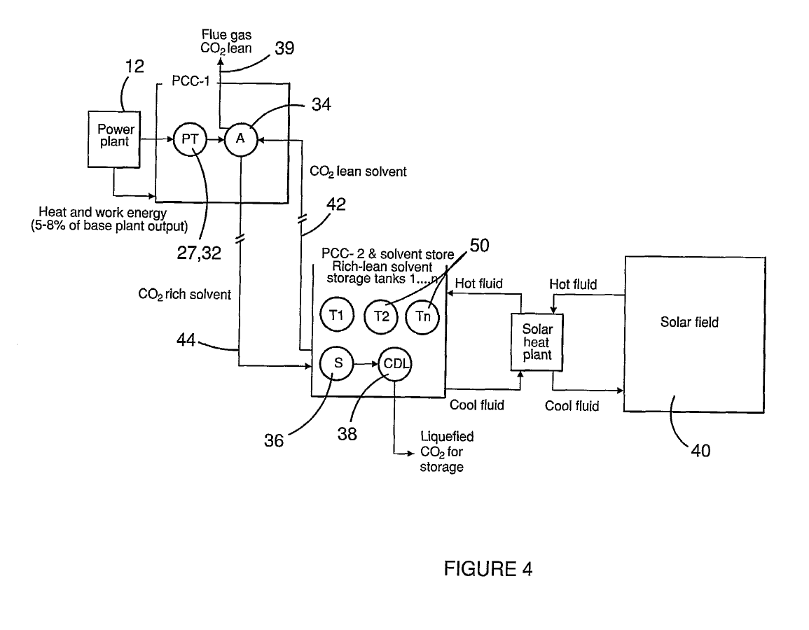

An additional embodiment is to use stored solar heat for desorption during periods of low or no insolation. There are a wide range of options for achieving this, but one suitable configuration is shown schematically in FIG. 4.

The invention has a number of advantages over the direct use of solar heat energy for CO₂ capture processes:

1. Heat transfer fluids from the solar field(s) need only be transferred to the desorber, which can be advantageously located closer to the solar field(s) 40. This reduces the energy losses and need for thermal insulation of these pipes. It also avoids the problem of heat losses associated with the transfer of hot working fluids between the solar field and a conventional absorber-desorber combination.

Overall, the concept enables the solar field(s) to be advantageously located further from the absorber without efficiency penalties caused by heat loss from transferring hot fluids over long distances.

2. The solvents rather than the solar-heated working fluid are transferred over the longer distance between the absorber and the desorber, which has a number of advantages:
For most solvents, the pipes will be smaller in diameter than those required to transfer heat energy to the desorber as hot pressurized water.
The solvent fluids are transferred at temperatures closer to ambient, which reduces the need for thermal insulation.

Heat losses from the CO₂-lean regenerated solvent returning to the absorber from the desorber storage tanks will be advantageous for the absorption stage.
In some applications it may be advantageous to thermally insulate the CO₂-rich solvent pipe 42, to reduce the heat energy required at the desorber—however, this insulation requirement is much less demanding than the insulation required if the desorber was co-located with the absorber.

3. The solvent streams are beneficially stored in a number of locations, preferably adjacent to the solar field, to enable flexible operation of the desorber to maximise use of the solar field, and to minimize the solvent pipe size 44 back to the absorber. Storage of CO₂-rich solvent enables more solvent to be desorbed during periods of high insolation; the lean solvent can be stored indefinitely, enabling the absorber to operate when solar energy is not available.

4. The use of a number of solvent storage tanks with varying levels of CO₂ loading will enable the desorption stage to be optimized with the available solar energy.

Moreover, storage of the CO₂-lean solvent is an especially effective means of low-cost storage of solar energy for periods of low or zero insolation.

In solar shoulder periods, the thermal efficiency of the solar field will be higher if a lower temperature is provided to the heat transfer fluid. Under these conditions it may be advantageous to partially strip only the richest solvent.

The desorber can be operated at temperatures and pressures which allow optimization of the use of the solar energy for the CO₂ desorption and liquefaction stages.

This combined heat and power option will have significantly higher efficiency than for power generation alone.

5. The solar field(s) can be configured to provide energy for a number of other purposes which may integrate with the desorber and/or provide work or electrical energy. For example, steam or other vapours could be supplied from the solar field(s) to drive a turbine to provide CO₂ compression work, and the exhaust from the turbine can then provide a proportion of the heat energy for the desorption and dehydration processes, and heat from CO₂ compression can be used to augment solar heat source(s).

6. For power generation, the invention provides a low cost method of avoiding a reduction in electricity generation due to post combustion capture. Overall the invention in effect uses solar energy to at least partially offset electricity generation and electricity storage. This approach is the lowest cost for both, and offers a low risk route for large scale use of solar thermal energy.

7. In summary, for electricity generation, the invention provides emissions-free energy for the CO₂ capture process and avoids the loss of electrical output from the host power plant (20-25%), thereby giving a saving in both capital and operating costs, and a 20-25% reduction in the amount of CO₂ to be captured for a given electrical output. The invention is also applicable to other large scale stationary sources of CO₂.

1. A method of recovering CO₂ from a gas stream, including:
at an absorber station, absorbing CO₂ from a gas stream into a suitable solvent whereby to convert said solvent into a CO₂-enriched medium;
conveying the CO₂-enriched medium to a desorber station nearer to a solar energy field than to said absorber station;
employing working fluid, heated in said solar energy field by insolation, to effect desorption of CO₂ from said CO₂-enriched medium at said desorber station, whereby to produce separate CO₂ and regenerated solvent streams; and
recycling the regenerated solvent stream to said absorber station.

2. A method according to claim 1 wherein the CO₂-enriched medium and/or the regenerated solvent stream are selectively accumulated so as to respectively optimise the timing and rate of said absorption and desorption of CO₂ and/or to provide a storage of solar energy.

3. A method according to claim 1 wherein the absorber station is located adjacent a source of the gas stream.

4. A method according to claim 3 wherein said source of the gas stream is a boiler or furnace to which said gas stream is being fed or from which said gas stream is emitted; as a flue gas stream.

5. A method according to claim 4 wherein said boiler or furnace is part of an electrical power generation plant.

6. A method according to claim 4 wherein said boiler or furnace is part of a coalfired electrical power station.

7. A method according to claim 1 wherein said working fluid, heated in said solar field by insolation, is also employed as an energy source in compression and liquefaction of the CO₂ in said separate CO₂ stream.

8. Apparatus for recovering CO₂ from a gas stream, including:
an absorber station arranged to receive the gas stream and to absorb CO₂ from the gas stream into a suitable solvent whereby to convert said solvent into a CO₂-enriched medium;
a solar energy field;
a desorber station disposed nearer to the solar energy field than to the absorber station; and
means to convey the CO₂-enriched medium from the absorber station to the desorber station;
wherein said desorber station is configured to employ working fluid, heated in said solar energy field by insolation, to effect desorption of CO₂ from said CO₂-enriched medium at said desorber station, whereby to produce separate CO₂ and regenerated solvent streams; and wherein means is provided to recycle the regenerated solvent stream to said absorber station.

9. Apparatus according to claim 8, further including a plurality of storage vessels whereby the CO₂-enriched medium and/or the regenerated solvent stream are selectively accumulated in the vessels so as to respectively optimise the timing and rate of said absorption and desorption of CO₂ and/or to provide a storage of solar energy.

10. Apparatus according to claim 8 wherein the absorber station is located adjacent a source of the gas stream.

11. Apparatus according to claim 10 wherein said source of the gas stream is a boiler or furnace to which said gas stream is being fed or from which said gas stream is emitted as a flue gas stream.

12. Apparatus according to claim 11 wherein said boiler or furnace is part of an electrical power generation plant

13. Apparatus according to claim 11 wherein said boiler or furnace is part of a coalfired electrical power station.

14. Apparatus according to claim 8 further including means to compress and liquefy the CO₂ in said separate CO₂ stream, and means to. convey said working fluid, heated in said field by insolation, to such means for use as an energy source in said compression and liquefaction.

15. A method of injecting solar energy into a power generation or other industrial system, including:
directing a process gas stream for or from the power generation or other industrial system to an absorber station, and therein absorbing CO₂ from the gas stream into a suitable solvent whereby to convert said solvent into a CO₂-enriched medium;
conveying the CO₂-enriched medium to a desorber station nearer to a solar energy field than to said absorber station;
employing working fluid, heated in said solar energy field by insolation, to effect desorption of CO₂ from said CO₂-enriched medium at said desorber station, whereby to produce separate CO₂ and regenerated solvent streams; and
recycling the regenerated solvent stream to said absorber station.

16. A method according to claim 15 wherein the CO₂-enriched medium and/or the regenerated solvent stream are selectively accumulated so as to respectively optimise the timing and rate of said absorption and desorption of CO₂ and/or to provide a storage of solar energy,

17. A method according to claim 15 wherein the absorber station is located adjacent a source of the gas stream.

18. A method according to claim 17 wherein said source of the gas stream is a boiler or furnace to which said gas stream is being fed or from which said gas stream is emitted as a flue gas stream.

19. A method according to claim 18 wherein said boiler or furnace is part of an electrical power generation plant.

20. A method according to claim 18 wherein said boiler or furnace is part of a coalfired electrical power station.

21. A method according to claim 15 wherein said working fluid, heated in said solar field by insolation, is also employed as an energy source in compression and liquefaction of the CO₂ in said separate CO₂ stream.

22. Apparatus for injecting solar energy into a power generation or other industrial system, including:
an absorber station arranged to receive a process gas stream for or from the power generation or other industrial system and therein to absorb CO₂ from the gas stream into a suitable solvent whereby to convert said solvent into a CO₂-enriched medium;
a solar energy field; a desorber station disposed nearer to the solar energy field than to said absorber station; and
means to convey the CO₂-enriched medium from the absorber station to the desorber station;
wherein said desorber station is configured to employ working fluid, heated in said solar energy field by insolation, to effect desorption of CO₂ from said CO₂-enriched medium at said desorber station, whereby to produce separate CO₂ and regenerated solvent streams; and
wherein means is provided to recycle the regenerated solvent stream to said absorber station.

23. Apparatus according to claim 22, further including a plurality of storage vessels whereby the CO₂-enriched medium and/or the regenerated solvent stream are selectively accumulated in the vessels so as to respectively optimise the timing and rate of said absorption and desorption of CO₂ and/or to provide a storage of solar energy.

24. Apparatus according to claim 22 wherein the absorber station is located adjacent a source of the gas stream.

25. Apparatus according to claim 24 wherein said source of the gas stream is a boiler or furnace to which said gas stream is being fed or from which said gas stream is emitted as a flue gas stream.

26. Apparatus according to claim 25 wherein said boiler or furnace is part of an electrical power generation plant.

27. Apparatus according to claim 25 wherein said boiler or furnace is part of a coalfired electrical power station.

28. Apparatus according to claim 22 further including means to compress and liquefy the CO₂ in said separate CO₂ stream, and means to convey said working fluid, heated in said field by insolation, to such means for use as an energy source in said compression and liquefaction.

29. A method of recovering CO₂ from a gas stream including:
at an absorber station absorbing CO₂ from the gas stream into a suitable solvent whereby to convert said solvent into a CO₂-enriched medium;
conveying the CO₂-enriched medium to a desorber station; and
employing working fluid, heated in a solar energy field by insolation, to effect desorption of CO₂ from said CO₂-enriched medium at said desorber station, whereby to produce separate CO₂ and regenerated solvent streams; and
recycling the regenerated solvent stream to said absorber station;
wherein the CO₂-enriched medium and/or the regenerated solvent stream are selectively accumulated so as to respectively optimise the timing and rate of said absorption and desorption of CO₂, and/or to provide a storage of solar energy.

30. A method according to claim 29 wherein the CO₂-enriched medium and/or the regenerated solvent stream are selectively accumulated so as to respectively optimise the timing and rate of said absorption and desorption of CO₂ and/or to provide a storage of solar energy.

31. A method according to claim 29 wherein the absorber station is located adjacent a source of the gas stream.

32. A method according to claim 31 wherein said source of the gas stream is a boiler or furnace to which said gas stream is being fed or from which said gas stream is emitted as a flue gas stream.

33. A method according to claim 32 wherein said boiler or furnace is part of an electrical power generation plant.

34. A method according to claim 33 wherein said boiler or furnace is part of a coal fired electrical power station.

35. A method according to claim 29 wherein said working fluid, heated in said solar field by insolation, is also employed as an energy source in compression and liquefaction of the CO₂ in said separate CO₂ stream.

36. Apparatus for recovering CO₂ from a gas stream, including:
an absorber station arranged to receive the gas stream and to absorb. CO₂ from the gas stream into a suitable solvent whereby to convert said solvent into a CO₂-enriched medium;
a solar energy field;
a desorber station; and
means to convey the CO₂-enriched medium from the absorber station to the desorber station;
wherein said desorber station is configured to employ working fluid, heated in said solar energy field by insolation, to effect desorption of CO₂ from said CO₂-enriched medium at said desorber station, whereby to produce separate CO₂ and regenerated solvent streams;
and wherein the apparatus further includes means to recycle the regenerated solvent stream to said absorber station, and a plurality of storage vessels whereby the CO₂-enriched medium and/or the regenerated solvent stream are selectively accumulated in the vessels so as to respectively optimise the timing and rate of said absorption and desorption of CO₂, and/or to provide a storage of solar energy.

37. Apparatus according to claim 36 wherein the absorber station is located adjacent a source of the gas stream.

38. Apparatus according to claim 37 wherein said source of the gas stream is a boiler or furnace to which said gas stream is being fed or from which said gas stream is emitted as a flue gas stream.

39. Apparatus according to claim 38 wherein said boiler or furnace is part of an electrical power generation plant.

40. Apparatus according to claim 38 wherein said boiler or furnace is part of a coal-fired electrical power station.

41. Apparatus according to claim 36 further including means to compress and liquefy the CO₂ in said separate CO₂ stream, and means to convey said working fluid, heated in said field by insolation to such means for use as an energy source in said compression and liquefaction.
